(19) United States
(12) Patent Application Publication
(10) Pub. No.: US 2015/0160758 A1
(43) Pub. Date: Jun. 11, 2015

(54) TOUCH PANEL WITH MESH ALLOY ELECTRODES

(71) Applicant: HengHao Technology Co. LTD, Taoyuan County (TW)

(72) Inventor: CHI-AN CHEN, Taipei City (TW)

(73) Assignee: HengHao Technology Co. LTD, Taoyuan County (TW)

(21) Appl. No.: 14/199,676

(22) Filed: Mar. 6, 2014

(30) Foreign Application Priority Data
Dec. 10, 2013 (TW) 102145476

(51) Int. Cl. G06F 3/044

(52) U.S. Cl. CPC G06F 3/044

(57) ABSTRACT

A touch panel with mesh alloy electrodes including first and second electrodes each having an alloy layer sandwiched between two transparent conductive layers. The second electrode is disposed in parallel with or stacked on the first electrode. Either one or both of the first and the second electrodes may include meshes.

### BACKGROUND OF THE INVENTION

1. Field of the Invention

The present invention generally relates to a touch panel, and more particularly to a touch panel with mesh alloy electrodes.

2. Description of Related Art

A touch screen is an input/output device that adopts sensing technology and display technology, and has been widely employed in electronic devices such as portable or hand-held electronic devices.

A capacitor-based touch panel is a commonly used touch panel that utilizes capacitive coupling effect to detect touch position. Specifically, when a finger touches a surface of the touch panel, capacitance corresponding to the touch position changes to detect the touch and touch position.

A high-temperature process is commonly adopted to manufacture a conventional touch panel with a touch electrode made of indium tin oxide (ITO) formed on a glass substrate. The conventional touch panel thus manufactured has a high resistivity and low light-transmittance. Moreover, trace phenomenon may occur to impact visual appearance when users look at the touch panel. The conventional touch panel has further disadvantages such as substantial thickness and complex process.

A need has thus arisen to propose a novel touch panel to overcome disadvantages of the conventional touch panel.

### SUMMARY OF THE INVENTION

In view of the foregoing, it is an object of the embodiment of the present invention to provide a touch panel with mesh alloy electrodes adaptable to a low-temperature process, with low resistivity, high light-transmittance and without trace phenomenon. Moreover, the thickness of the touch panel may be substantially reduced and its process simplified in some embodiments.

According to one embodiment, a touch panel includes a first electrode and a second electrode. The first electrode has an alloy layer sandwiched between two transparent conductive layers. The second electrode is disposed in parallel with or stacked on the first electrode, and the second electrode has an alloy layer sandwiched between two transparent conductive layers. The first electrode or the second electrode includes a plurality of meshes.

### BRIEF DESCRIPTION OF THE DRAWINGS

FIG. 1A shows a partial top view of a touch panel with mesh alloy electrodes according to a first embodiment of the present invention;

FIG. 1B shows a cross-sectional view along a section line 1B-1B′ in FIG. 1A;

FIG. 2 shows a cross-sectional view of a touch panel with mesh alloy electrodes according to a second embodiment of the present invention;

FIG. 3 shows a cross-sectional view of a touch display with mesh alloy electrodes according to a third embodiment of the present invention;

FIG. 4 shows a cross-sectional view of a touch display with mesh alloy electrodes according to a fourth embodiment of the present invention; and

FIG. 5 shows a cross-sectional view of a touch display with mesh alloy electrodes according to a fifth embodiment of the present invention.

### DETAILED DESCRIPTION OF THE INVENTION

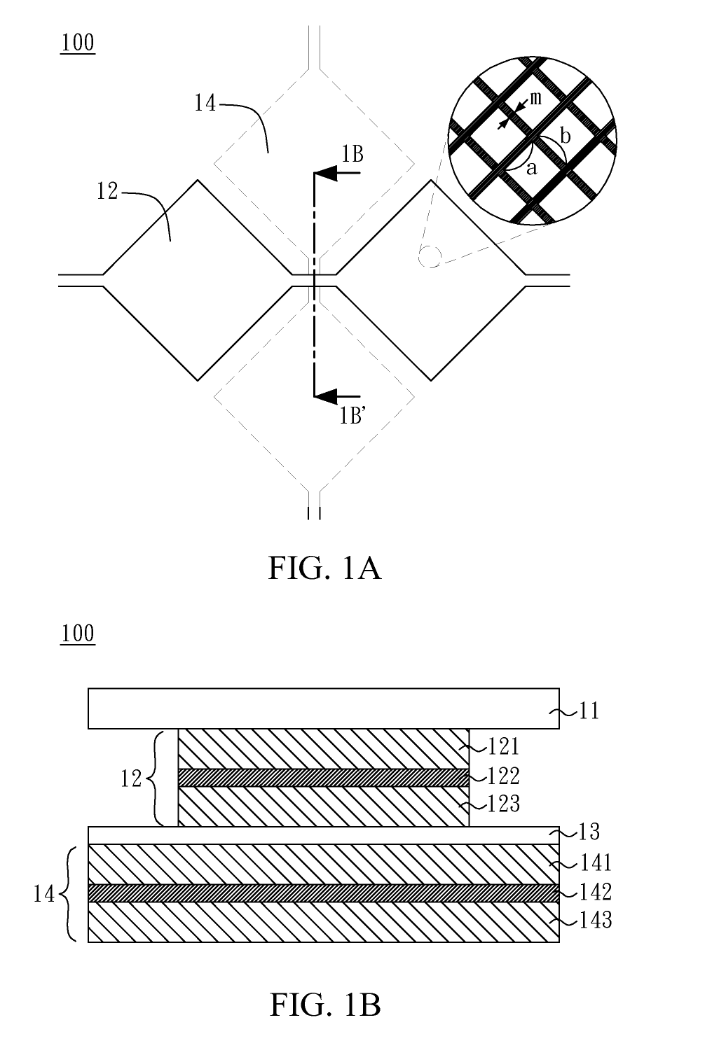

FIG. 1A shows a partial top view of a touch panel 100 with mesh alloy electrodes according to a first embodiment of the present invention. FIG. 1B shows a cross-sectional view along a section line 1B-1B′ in FIG. 1A. For a better understanding of the embodiment, only components pertinent to the embodiment are shown. A person skilled in the pertinent art may add other components according to architectures of a variety of conventional touch panels. In the specification, a direction “above” or “top” points to a touch position, and a direction “below” or “bottom” points against the touch position or to a display module (not shown).

As shown in FIG. 1A and FIG. 1B, a first electrode 12, such as a receive electrode (commonly called Rx electrode), is formed below a cover layer 11 and is disposed along a first (e.g., horizontal) direction. A second electrode 14, such as a transmit electrode (commonly called Tx electrode), is formed below the first electrode 12 and is disposed along a second (e.g., vertical) direction. A transparent insulating layer 13 is disposed between the first electrode 12 and the second electrode 14 in order to electrically insulate the first electrode 12 from the second electrode 14.

According to one aspect of the embodiment, as shown in FIG.

1B, the first electrode 12 has a stacked structure composed of an alloy layer 122 sandwiched between two transparent conductive layers (i.e., a top transparent conductive layer 121 and a bottom transparent conductive layer 123). Similarly, the stacked second electrode 14 includes an alloy layer 142 sandwiched between two transparent conductive layers (i.e., a top transparent conductive layer 141 and a bottom transparent conductive layer 143). In the embodiment, the transparent conductive layer 121/123/141/143 may, for example, be made of metal oxide, such as indium tin oxide (ITO), indium zinc oxide (IZO), Al-doped ZnO (AZO) or antimony tin oxide (ATO). In another embodiment, the transparent conductive layer 121/123/141/143 may be made of metal nanowires, such as silver nanowires or copper nanowires. In a further embodiment, some of the transparent conductive layer 121/123/141/143 may be made of metal oxide, while other of the transparent conductive layer 121/123/141/143 may be made of metal nanowires. The alloy layer 122/142 may, for example, be made of silver alloy (e.g., silver-aluminum alloy) or copper alloy.

As the embodiment utilizes the stacked first electrode 12 and the stacked second electrode 14 which include the top transparent conductive layer 121/141 and the bottom transparent conductive layer 123/143, a process temperature for manufacturing the touch panel 100 may thus be substantially reduced. Accordingly, the cover layer 11 acting as a substrate may be made of a material other than glass. That is, the cover layer 11 may, for example, be made of Polycarbonate (PC), Polyethylene terephthalate (PET), Polymethyl methacrylate (PMMA), Triacetyl Cellulose (TAC), Polyetheylen (PE), Poly vinyl chloride (PVC), Poly propylene (PP), Poly styrene (PS) or Cyclic olefin copolymer (COC).

According to another aspect of the embodiment, as shown in a magnified view in FIG. 1A, the first electrode 12 or the second electrode 14 includes meshes, which may be made by an etching process. Although only meshes of the first electrode 12 are shown in FIG. 1A, the second electrode 14 may include the same or similar meshes as well. The meshes of the second electrode 14 should be shifted from the meshes of the first electrode 12 such that a displacement exists horizontally between the first electrode 12 and the second electrode 14. In the embodiment, the mesh has a thickness m of about 5-50 micrometer, an opening ratio expressed as axb, where a or b represents a length of a side of the mesh. The length a or b of a side of the mesh may be 50-400 micrometer.

As the embodiment utilizes mesh first electrode 12 and mesh second electrode 14, resistivity may thus be substantially reduced, for example, to 5-20 Kohm. Moreover, as the thickness of the mesh is substantially small, light-transmittance of the touch panel 100 may thus be substantially enhanced, for example, to 80-90%. Further, as the opening ratio of the mesh in the embodiment is substantially small, trace phenomenon may be negligible.

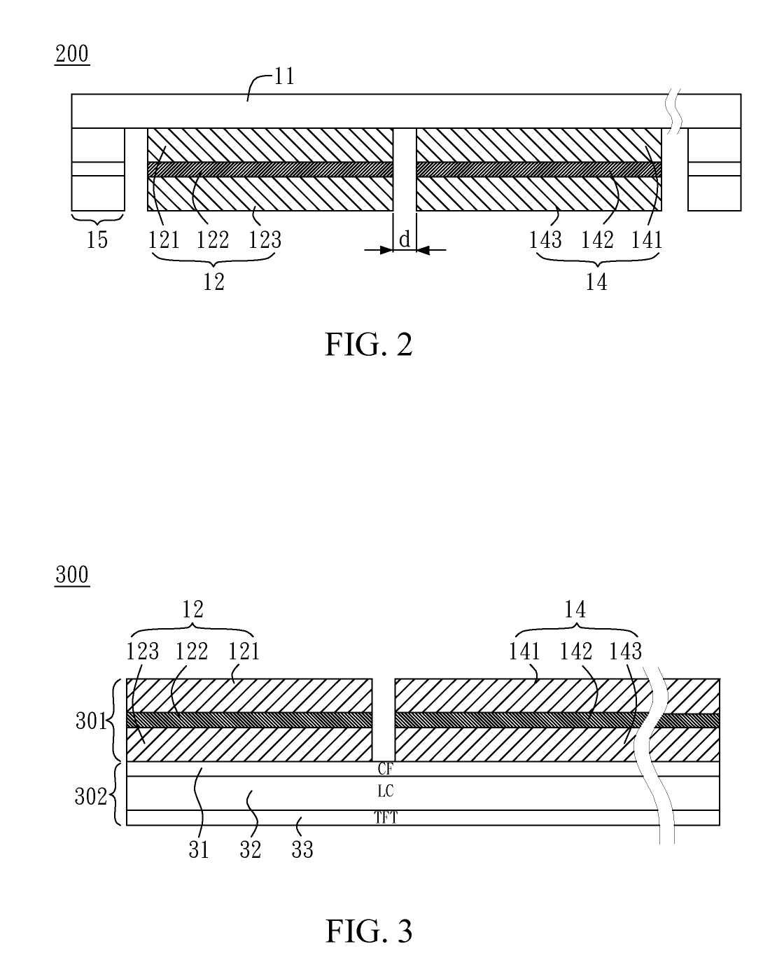

FIG. 2 shows a cross-sectional view of a touch panel 200 with mesh alloy electrodes according to a second embodiment of the present invention. The present embodiment, as distinct from the first embodiment (FIG. 1A and FIG. 1B), has the first electrode 12 and the second electrode 14 being disposed in parallel on the same plane below the cover layer 11, rather than being disposed vertically in a stack as in the first embodiment, therefore resulting in a one-layer touch panel 200 with a gap d existing between the first electrode 12 and the second electrode 14. The one-layer structure of the embodiment makes the thinning of the touch panel 200 feasible. In the embodiment, traces 15 on periphery of the touch panel 200 may be formed along with the first electrode and the second electrode 14 at the same time. In the conventional touch panel, on the contrary, electrodes are formed first, followed by forming traces. Accordingly, the present embodiment may simplify the process, reduce process time and cut down on cost.

FIG. 3 shows a cross-sectional view of a touch display 300 with mesh alloy electrodes according to a third embodiment of the present invention. The touch display 300 may be composed of a touch panel 301 and a display panel 302 that are stacked up, where the display panel 302 is disposed below the touch panel 301. The display panel 302 may include, from top to bottom, a color filter (CF) 31, a liquid crystal layer (LC) 32 and a thin-film transistor layer (TFT) 33. For better understanding the embodiment, only the first electrode 12 and the second electrode 14 of the touch panel 301 are shown. The first electrode 12 and the second electrode 14 are disposed in parallel (on the same plane) above the color filter 31.

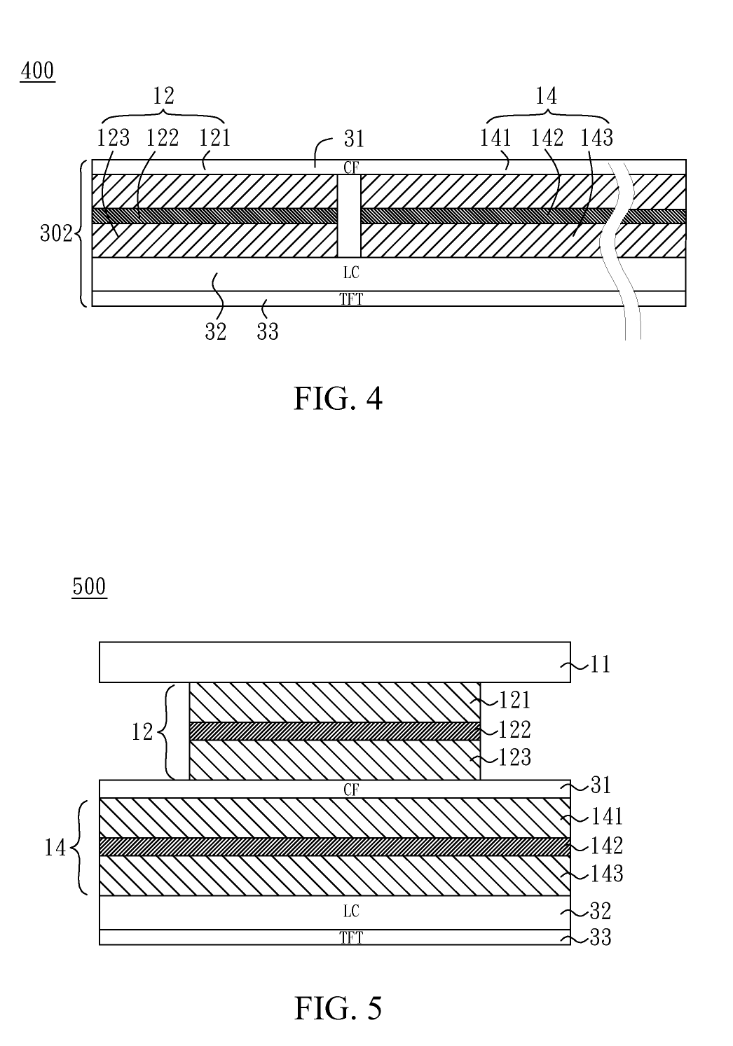

FIG. 4 shows a cross-sectional view of a touch display 400 with mesh alloy electrodes according to a fourth embodiment of the present invention. In the fourth embodiment, the first electrode 12 and the second electrode 14 are disposed in parallel (on the same plane) below the color filter 31, such that the first electrode 12 and the second electrode 14 are disposed between the color filter 31 and the liquid crystal layer 32. In other words, the first electrode 12 and the second electrode 14 of the embodiment are disposed in the display panel 302, therefore resulting in an in-cell touch display 400. As the first electrode 12 and the second electrode 14 are disposed near the liquid crystal layer 32, which cannot stand for high temperature, a low-temperature process due to the stacked first electrode 12 and the stacked second electrode 14 may be well adaptable to manufacturing the in-cell touch display 400.

FIG. 5 shows a cross-sectional view of a touch display 500 with mesh alloy electrodes according to a fifth embodiment of the present invention. In the fifth embodiment, the first electrode 12 is disposed above the color filter 31, and the second electrode 14 is disposed below the color filter 31.

The second embodiment (FIG. 2), the third embodiment (FIG. 3), the fourth embodiment (FIG. 4) and the fifth embodiment (FIG. 5) as well as the first embodiment may adopt stacked structure for the first electrode 12 and the second electrode 14. That is, the first electrode 12 may include, from top to bottom, a top transparent conductive layer 121, an alloy layer 122 and a bottom transparent conductive layer 123; and the second electrode 14 may include, from top to bottom, a top transparent conductive layer 141, an alloy layer 142 and a bottom transparent conductive layer 143. The top transparent conductive layer 121/141 and the bottom transparent conductive layer 123/143 may be made of metal oxide and/or metal nanowires. Moreover, the second embodiment (FIG. 2), the third embodiment (FIG. 3), the fourth embodiment (FIG. 4) and the fifth embodiment (FIG. 5) as well as the first embodiment may adopt mesh structure for the first electrode 12 and the second electrode 14. Accordingly, those embodiments may share the advantages of the first embodiment such as low-temperature process, low resistivity, high light-transmittance and negligible trace phenomenon.

Although specific embodiments have been illustrated and described, it will be appreciated by those skilled in the art that various modifications may be made without departing from the scope of the present invention, which is intended to be limited solely by the appended claims.

What is claimed is:

1. A touch panel with mesh alloy electrodes, including:
a first electrode having an alloy layer sandwiched between two transparent conductive layers; and
a second electrode disposed in parallel with or stacked on the first electrode, the second electrode having an alloy layer sandwiched between two transparent conductive layers;
wherein at least one of the first electrode and the second electrode includes a plurality of meshes.

2. The touch panel of claim 1, wherein at least one of the first electrode and the second electrode comprises metal oxide.

3. The touch panel of claim 2, wherein the metal oxide comprises one of a group consisting of indium tin oxide (ITO), indium zinc oxide (IZO), Al-doped ZnO (AZO) and antimony tin oxide (ATO).

4. The touch panel of claim 1, wherein at least one of the first electrode and the second electrode comprises metal nanowires.

5. The touch panel of claim 4, wherein the metal nanowires comprise at least one of silver nanowires and copper nanowires.

6. The touch panel of claim 1, wherein the alloy layer of at least one of the first electrode and the second electrode comprises at least one of silver alloy and copper alloy.

7. The touch panel of claim 1, wherein each of the plurality of meshes has a thickness of 5-50 micrometer.

8. The touch panel of claim 1, wherein each of the plurality of meshes has an opening ratio expressed as axb, wherein a or b represents a side length of 50-400 micrometer.

9. The touch panel of claim 1, further comprising a cover layer below which the first electrode is disposed, the second electrode being stacked on the first electrode via a transparent insulating layer.

10. The touch panel of claim 9, wherein the cover layer comprises one of a group consisting of glass, Polycarbonate (PC), Polyethylene terephthalate (PET), Polymethyl methacrylate (PMMA), Triacetyl Cellulose (TAC), Polyetheylen (PE), Poly vinyl chloride (PVC), Poly propylene (PP), Poly styrene (PS) and Cyclic olefin copolymer (COC).

11. The touch panel of claim 1, further comprising a cover layer below which the first electrode and the second electrode are disposed in parallel on a same plane.

12. The touch panel of claim 11, wherein the cover layer comprises one of a group consisting of glass, Polycarbonate (PC), Polyethylene terephthalate (PET), Polymethyl methacrylate (PMMA), Triacetyl Cellulose (TAC), Polyetheylen (PE), Poly vinyl chloride (PVC), Poly propylene (PP), Poly styrene (PS) and Cyclic olefin copolymer (COC).

13. The touch panel of claim 11, further comprising traces formed on the same plane as the first electrode and the second electrode.

14. The touch panel of claim 1, wherein the first electrode and the second electrode are disposed in parallel and above a color filter of a display panel.

15. The touch panel of claim 1, wherein the first electrode and the second electrode are disposed in parallel and between a color filter and a liquid crystal layer of a display panel.

16. The touch panel of claim 1, wherein the first electrode is disposed above a color filter of a display panel, and wherein the second electrode is disposed below the color filter.
